(19) United States
(12) Patent Application Publication
(10) Pub. No.: US 2006/0271318 A1
(43) Pub. Date: Nov. 30, 2006

(54) Dual spectrum analyzer measurement system

(76) Inventor: Wing J. Mar, Rohnert Park, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/139,188

(22) Filed: May 27, 2005

(51) Int. Cl. G06F 19/00

(52) U.S. Cl. 702/71

(57) ABSTRACT

A dual spectrum analyzer measurement system reduces the effects of noise on acquired measurements, enabling power of a received input signal, and the noise of each spectrum analyzer in the dual spectrum analyzer measurement system, to be determined.

### BACKGROUND OF THE INVENTION

In many measurement applications, the measurement sensitivity of a spectrum analyzer can be improved by reducing the effects of the noise on measurements that are acquired by the spectrum analyzer. Noise subtraction, one technique that is used to reduce the effects of noise, involves accurately characterizing the noise of the spectrum analyzer and subtracting the characterized noise from measurements that are acquired by the spectrum analyzer. However, this type of noise characterization can be time-consuming because it typically relies on averaging many repetitive measurements by the spectrum analyzer. In addition, the repetitive measurements also encompass a wide range of carrier measurement frequencies and offset frequencies to accommodate the various operating states that associated with the broad measurement capabilities of a typical spectrum analyzer.

A signal source analyzer is a dual channel measurement system that reduces the effects of noise on acquired measurements. While the signal source analyzer has high measurement sensitivity and can provide low-noise measurements of a received signal, the signal source analyzer lacks the frequency selectivity, image frequency rejection, and the broad measurement capabilities of a spectrum analyzer, which is a more general-purpose and more ubiquitous type of measurement instrument.

Accordingly, there is a need for a measurement system that reduces the effects of noise on measurements that are acquired by the measurement system, while maintaining the broad measurement capabilities of a spectrum analyzer.

### SUMMARY OF THE INVENTION

A dual spectrum analyzer measurement system according to the embodiments of the present invention reduces the effects of noise on acquired measurements, enabling the power of a received input signal, and the noise of each spectrum analyzer in the dual spectrum analyzer measurement system, to be determined.

### BRIEF DESCRIPTION OF THE DRAWINGS

FIGS. 1A-1B show attributes of a spectrum analyzer measurement.

FIG. 2 shows a dual spectrum analyzer measurement system according to embodiments of the present invention.

FIG. 3 shows one example of an averaged cross-correlation signal provided according to embodiments of the present invention.

### DETAILED DESCRIPTION

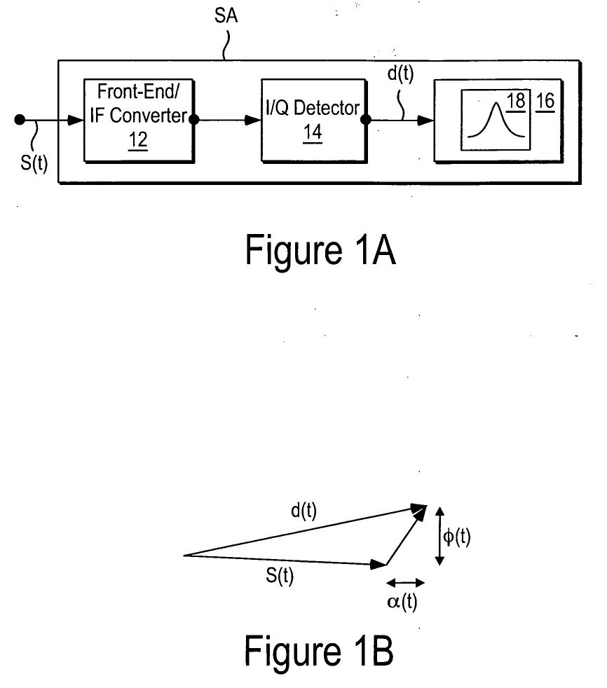

FIG. 1A shows attributes of a spectrum analyzer measurement. A typical spectrum analyzer SA includes a front-end/intermediate-frequency (IF) converter 12 that receives an input signal s(t), and provides an IF signal (not shown) in response to the received input signal s(t). A quadrature (IQ) detector 14 receives the IF signal and provides a measured signal d(t) to a display unit 16 that is coupled to the IQ detector 14. The measured signal d(t) is typically a digital signal that includes sets of samples that represent the magnitude and phase of the input signal s(t) versus frequency. The display unit 16 processes the measured signal d(t) to provide a representation of the spectral content of the input signal s(t) on a display 18 or other output device.

The spectrum analyzer SA contributes noise n(t) to the measured signal d(t) that is acquired by the spectrum analyzer. FIG. 1B shows a phasor representation of the measured signal d(t) as influenced by the noise n(t). The measured signal d(t) is shown as the vector sum of the input signal s(t) and the noise n(t) of the spectrum analyzer SA. The noise n(t) is represented by a time-varying vector that has a phase component of magnitude Φ(t) and an amplitude component of magnitude α(t). The measured signal d(t) is expressed in equation (1), according to the input signal s(t), the phase component of magnitude Φ(t), and amplitude component of magnitude α(t). The signals in equation (1) are typically frequency-dependent and time-dependent.
d(t)=s(t)+α(t)+jΦ(t) (1)

The power p of the measured signal d(t) can be represented by equation (2).

$$\begin{matrix}p = ( s ( t ) + a ( t ) + jΦ ( t ) ) ( s ( t ) + a ( t ) - jΦ ( t ) ) \\ = {s}^{2} ( t ) + 2 s ( t ) a ( t ) + {a}^{2} ( t ) + {Φ}^{2} ( t )\end{matrix} \qquad ( 2 )$$

To reduce the effects of the noise n(t) on the measured signal d(t), the spectrum analyzer SA typically acquires N repetitive measurements of the input signal s(t) and averages the N measurements to minimize the variance of the measurements. Averaging the power of the measured signal d(t) results in a mean power pₘₑₐₙ of the measured signal d(t) that is expressed according to equation (3), where the signals that are associated with the N repetitive measurements acquired by the spectrum analyzer SA are indexed with the subscript i.

$$\begin{matrix}{p}_{mean} = \frac{1}{N} {\sum }_{i = 1}^{N} {p}_{i} \\ = \frac{1}{N} {\sum }_{i = 1}^{N} {s}_{i}^{2} + \frac{1}{N} {\sum }_{i = 1}^{N} 2 \cdot {s}_{i} \cdot {α}_{i} + \frac{1}{N} {\sum }_{i = 1}^{N} {α}_{i}^{2} + \frac{1}{N} {\sum }_{i = 1}^{N} {Φ}_{i}^{2} \\ ≅ \frac{1}{N} {\sum }_{i = 1}^{N} {s}_{i}^{2} + \frac{1}{N} {\sum }_{i = 1}^{N} {α}_{i}^{2} + \frac{1}{N} {\sum }_{i = 1}^{N} {Φ}_{i}^{2} for N -> ∞\end{matrix} \qquad ( 3 )$$

According to equation (3), when N, the number of repetitive measurements of the input signal s(t), is sufficiently large, the mean power pₘₑₐₙ of the measured signal d(t) is approximately equal to the mean power psₘₑₐₙ of the input signal s(t), where

$$p {s}_{mean} = \frac{1}{N} {\sum }_{i = 1}^{N} {s}_{i}^{2} ,$$

plus the mean power

$$\frac{1}{N} {\sum }_{i = 1}^{N} {α}_{i}^{2}$$

of the amplitude component of magnitude α(t) and the mean power

$$\frac{1}{N} {\sum }_{i = 1}^{N} {Φ}_{i}^{2}$$

of the phase component of magnitude Φ(t). The sum of the last two terms in equation (3), the mean power of the amplitude component

$$\frac{1}{N} {\sum }_{i = 1}^{N} {α}_{i}^{2}$$

and the mean power of the phase component

$$\frac{1}{N} {\sum }_{i = 1}^{N} {Φ}_{i}^{2} ,$$

represent the mean power pₙₒᵢₛₑ of the noise n(t) contributed by the spectrum analyzer SA.

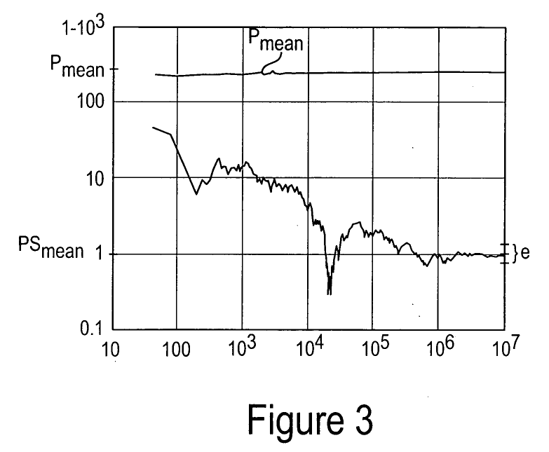

FIG. 3 shows one example of a plot of the mean power pₘₑₐₙ of the measured signal d(t) versus N, the number of repetitive measurements of the input signal s(t). FIG. 3 indicates, that in this example, the mean power pₘₑₐₙ of the measured signal d(t) is substantially greater than the mean power psₘₑₐₙ of the input signal s(t). Accordingly, the noise n(t) of the spectrum analyzer in this example is sufficiently high to mask the input signal s(t).

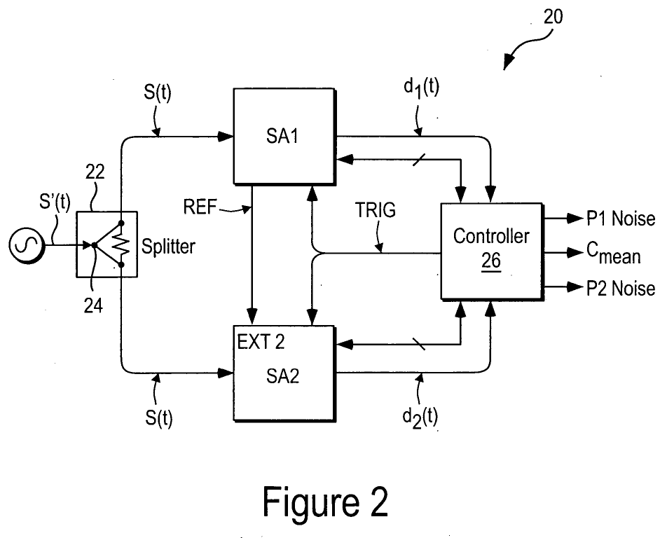

FIG. 2 shows a dual spectrum analyzer measurement system 20, designated as measurement system 20, according to embodiments of the present invention. In the configuration of FIG. 2, a power divider, coupler, or other type of signal splitter 22 couples an input 24 to each of two spectrum analyzers SA1, SA2. The signal splitter 22 separates an applied input signal s′(t), provided at the input 24, into two input signals s(t). In this example, the signal splitter 22 provides signal paths to each of the spectrum analyzers SA1, SA2 that have equivalent path length and coupling factor, so that the signals provided to each of the spectrum analyzers SA1, SA2 are equal in amplitude and have equal phase. Due to the balance of the signal splitter 22, the resulting input signals that are applied to the spectrum analyzers are each designated as an input signal s(t).

The measurement frequencies of the spectrum analyzers SA1, SA2 are frequency-aligned via a reference signal REF that is common to both of the spectrum analyzers SA1, SA2. The frequency alignment is typically achieved by locking the timebases of the two spectrum analyzers SA1, SA2 together with the reference signal REF. In one example, the reference signal REF is provided by a signal source (not shown) that is external to both of the spectrum analyzers SA1, SA2 and coupled to the external reference ports of each of the spectrum analyzers SA1, SA2. Alternatively, the reference signal REF is an internal reference signal that is provided by one of the spectrum analyzers and coupled to the external reference port of the other of the spectrum analyzers SA1, SA2. In the example shown in FIG. 2, the frequency alignment is provided by an internal reference signal REF of the spectrum analyzer SA1 that is coupled to the external reference port EXT2 of the spectrum analyzer SA2.

Typically, the reference signal REF contributes to the phase noise of measured signals d₁(t), d₂(t) that are acquired by the spectrum analyzers SA1, SA2, respectively. Because the reference signal REF is common to both of the spectrum analyzers SA1, SA2, the noise contributed by the reference signal REF to the measured signals d₁(t), d₂(t) is coherent. Accordingly, cross-correlation averaging of the measured signals d₁(t), d₂(t) does not remove the phase noise that is due to the reference signal REF. The phase noise attributed to the reference signal REF is typically within a one hundred Hertz frequency offset from the carrier measurement frequencies of the spectrum analyzers, SA1, SA2, due to the typically narrow loop bandwidth of the reference phase-locked loops (not shown) within the spectrum analyzers SA1, SA2.

The measurement system 20 includes a controller 26 that is coupled to the spectrum analyzers SA1, SA2. The controller 26 can be external to the spectrum analyzers SA1, SA2, or the controller 26 can be a computer or other processor that is included in one, or both, of the spectrum analyzers SA1, SA2. The controller 26 receives and processes the measured signal d₁(t) from the spectrum analyzer SA1, and the measured signal d₂(t) from the spectrum analyzer SA2. The controller 26 also provides time alignment, typically via a trigger signal TRIG to the spectrum analyzers SA1, SA2, for the measurements of the input signals s(t) that are acquired by the spectrum analyzers SA1, SA2. The trigger signal TRIG can be provided by an external signal source (not shown), or by the controller 26 as shown in FIG. 2. The time-alignment synchronizes or otherwise coordinates the measurement acquisitions by the spectrum analyzers SA1, SA2 so that the measured signals d₁(t), d₂(t) are acquired at corresponding times and positions on each of the input signals s(t). Typically, the measured signals d₁(t), d₂(t) are digital signals including sets of samples that are acquired at designated times and that represent the amplitudes and phases of the input signals s(t) as a function of frequency. When the input signals s(t) to each of the spectrum analyzers SA1, SA2 do not have equivalent amplitudes and phases, due to imbalances in the signal splitter 22, the controller 26 can compensate the measured signals d₁(t), d₂(t) to accommodate for the imbalances, for example, by adjusting the amplitudes or phases that are represented in the measured signals d₁(t), d₂(t).

The spectrum analyzers SA1, SA2 typically have similar programmability and I/O (input/output) features to facilitate programming of the operating states of the spectrum analyzers and processing of the measured signals d₁(t), d₂(t). The spectrum analyzers SA1, SA2 also typically have sufficiently similar operating characteristics so that both spectrum analyzers SA1, SA2 can accommodate the reference signal REF and the trigger signal TRIG. The noise of the spectrum analyzers SA1, SA2 can have different characteristics, and in general, noise n₁(t) of the spectrum analyzer SA1 is not coherent with noise n₂(t) of the spectrum analyzer SA2.

The spectrum analyzer SA1 has a front-end/intermediate-frequency (IF) converter 12 (not shown) that receives the input signal s(t) and provides an IF signal (not shown) in response to the received input signal s(t). A quadrature (IQ) detector 14 (not shown) within the spectrum analyzer SA1 receives the IF signal and provides the measured signal d₁(t) to the controller 26.

The spectrum analyzer SA1 contributes the noise n₁(t) to the measured signal d₁(t) that is acquired by the spectrum analyzer SA1. The measured signal d₁(t) can be represented as the vector sum of the input signal s(t) and the noise n₁(t) of the spectrum analyzer SA1, where the noise n₁(t) is represented by a time-varying vector that has a phase component of magnitude Φ₁(t) and an amplitude component of magnitude α₁(t). The measured signal d₁(t) is expressed in equation (4) according to the input signal s(t), the phase component of magnitude Φ₁(t), and amplitude component of magnitude α₁(t). The signals in equation (4) are typically frequency-dependent and time-dependent.
d₁(t)=s(t)+α₁(t)+jΦ₁(t) (4)

The measured signal d₂(t), provided by the spectrum analyzer SA2, can be represented as the vector sum of the input signal s(t) and the noise n₂(t) of the spectrum analyzer SA2, where the noise n₂(t) is represented by a time-varying vector that has a phase component of magnitude Φ₂(t), and an amplitude component of magnitude α2(t). The measured signal d₂(t) is expressed in equation (5) according to the input signal s(t), the phase component of magnitude Φ₂(t), and amplitude component of magnitude α2(t). The signals in equation (5) are typically frequency-dependent and time-dependent.
d₂(t)=s(t)+α₂(t)+jΦ₂(t) (5)

The controller 26 programs the operating states of the spectrum analyzers SA1, SA2 to acquire repetitive measurements of the input signals s(t), resulting in N acquisitions of each of the measured signals d₁(t), d₂(t). The controller 26 receives the measured signals d₁(t), d₂(t) and processes the measured signals d₁(t), d₂(t) to establish a cross-correlation averaging of measured signals d₁(t), d₂(t) based on the repetitive measurements, to provide an averaged cross-correlation signal Cₘₑₐₙ. The averaged cross-correlation signal Cₘₑₐₙ is expressed in equation (6), where the signals that are associated with the N repetitive measurement acquisitions of the measured signals d₁(t), d₂(t) are indexed with the subscript i.

$$\begin{matrix}{C}_{mean} = \frac{1}{N} {\sum }_{i = 1}^{N} ( {s}_{i} + {α}_{1 i} + {jΦ}_{1 i} ) \cdot ( {s}_{i} + {α}_{2 i} - {jΦ}_{2 i} ) \\ = \frac{1}{N} {\sum }_{i = 1}^{N} {s}_{i}^{2} + \frac{1}{N} {\sum }_{i = 1}^{N} {s}_{i} \cdot ( {α}_{1 i} + {α}_{2 i} ) + \\ \frac{1}{ N} {\sum }_{i = 1}^{ N} {α}_{ 1 i} \cdot {α}_{ 2 i} + \frac{1}{ N} {\sum }_{i = 1}^{ N} {Φ}_{ 1 i} \cdot {Φ}_{ 2 i} + \\ \frac{j}{N} {\sum }_{i = 1}^{N} [ {s}_{i} \cdot ( {Φ}_{1 i} - {Φ}_{2 i} ) + {Φ}_{1 i} \cdot {α}_{2 i} - {Φ}_{2 i} \cdot {α}_{1 i} ] \\ ≅ \frac{1}{N} {\sum }_{i = 1}^{N} {s}_{i}^{2} for N -> ∞\end{matrix} \qquad ( 6 )$$

According to equation (6), when N, the number of repetitive measurements of the measured signals d₁(t), d₂(t) is sufficiently high, the averaged cross-correlation signal Cₘₑₐₙ is approximately equal to the mean power psₘₑₐₙ of the input signal s(t). Therefore, with a sufficient number of repetitive measurement acquisitions, N, the cross-correlation averaging of the two measured signals d₁(t), d₂(t) provides an approximation of the mean power psₘₑₐₙ of the input signal s(t) that is independent of the noise n₁(t), n₂(t) of the spectrum analyzers SA1, SA2 and that is accurate to within a designated error e.

FIG. 3 shows one example of an averaged cross-correlation signal Cₘₑₐₙ provided according to embodiments of the present invention. FIG. 3 indicates that as the number of repetitive measurements, N, increases, the power of the averaged cross-correlation signal Cₘₑₐₙ converges to the mean power psₘₑₐₙ of the input signal s(t). FIG. 3 also illustrates that the mean power psₘₑₐₙ of the input signal s(t) can be determined even when the noise n₁(t), n₂(t) of the spectrum analyzers SA1, SA2 is high enough to mask the input signals s(t) to the spectrum analyzers SA1, SA2.

The cross-correlation averaging provided by the controller 26 is typically performed as a running cross-correlation average of the measured signals d₁(t), d₂(t) as the N repetitions of the measured signals d₁(t), d₂(t) are acquired. This enables the averaged cross-correlation signal Cₘₑₐₙ to be established without storing all of the N repetitive acquisitions of the measured signals d₁(t), d₂(t).

According to alternative embodiments of the present invention, the averaged cross-correlation signal Cₘₑₐₙ is used to determine the power of the noise of each of the spectrum analyzers SA1, SA2. For example, equation (3) indicates that when N is sufficiently high, the mean power p₁ₘₑₐₙ of the measured signal d₁(t) provided by the spectrum analyzer SA1 can be approximated by the sum of the mean power psₘₑₐₙ of the input signal s(t) and the power p₁ₙₒᵢₛₑ of the noise n₁(t) of the spectrum analyzer SA1. Since the averaged cross-correlation signal Cₘₑₐₙ approximates the mean power psₘₑₐₙ of the input signal s(t), the power p₁ₙₒᵢₛₑ of the noise n₁(t) of the spectrum analyzer SA1 is approximately equal to the mean power p₁ₘₑₐₙ of the measured signal d₁(t) minus the averaged cross-correlation signal Cₘₑₐₙ. Similarly, when N is sufficiently high, the mean power p₂ₘₑₐₙ of the measured signal d₂(t) provided by the spectrum analyzer SA2 can be approximated by the sum of the mean power psₘₑₐₙ of the input signal s(t) and the power p₂ₙₒᵢₛₑ of the noise n₂(t) of the spectrum analyzer SA2. Since the averaged cross-correlation signal Cₘₑₐₙ approximates the mean power psₘₑₐₙ of the input signal s(t), the power p₂ₙₒᵢₛₑ of the noise n₂(t) of the spectrum analyzer SA2 is approximately equal to the mean power p₂ₘₑₐₙ of the measured signal d₂(t) minus the averaged cross-correlation signal Cₘₑₐₙ.

Establishing the power of the noise of either one of the spectrum analyzers SA1, SA2 enables noise subtraction to be applied to subsequent measured signals acquired by that spectrum analyzer. For example, when the spectrum analyzer SA1 is used in a measurement configuration shown in FIG. 1A to measure an applied input signal, the power p₁ₙₒᵢₛₑ of the noise n₁(t) of the spectrum analyzer SA1 can be subtracted from an average of repetitive measurements of the measured signal d₁(t) acquired by the spectrum analyzer SA1 to determine the power of the input signal that is applied to the spectrum analyzer SA1. Accordingly, once the averaged cross-correlation signal Cₘₑₐₙ is determined using the dual spectrum analyzer measurement system 20 and the power p₁ₙₒᵢₛₑ of the noise n₁(t) of the spectrum analyzer SA1 are established according to embodiments of the present invention, the effects of the noise n₁(t) of the spectrum analyzer SA1 can be reduced using noise subtraction when the spectrum analyzer SA1 is used in a one spectrum analyzer measurement configuration to make measurements of applied input signals. Noise subtraction applied in this manner enables the mean power psₘₑₐₙ of the input signal s(t) to be determined within a designated error with a relatively low number of repetitive measurements of the measured signal d₁(t) being acquired by the spectrum analyzer SA1.

While the embodiments of the present invention have been illustrated in detail, it should be apparent that modifications and adaptations to these embodiments may occur to one skilled in the art without departing from the scope of the present invention as set forth in the following claims.

1. A system, comprising:
a first spectrum analyzer;
a second spectrum analyzer frequency-aligned with the first spectrum analyzer; and
a controller receiving a first measured signal provided by the first spectrum analyzer in response to a received input signal, and receiving a second measured signal provided by the second spectrum analyzer in response to the received input signal, the controller averaging a cross-correlation of multiple acquisitions of the first measured signal and the second measured signal to approximate the mean power of the input signal.

2. The system of claim 1 wherein the number of multiple acquisitions of the first measured signal and the second measured signal is sufficiently high to approximate the mean power of the input signal to within a designated error.

3. The system of claim 1 wherein the first spectrum analyzer and the second spectrum analyzer are frequency-aligned via an external reference signal that is provided to the first spectrum analyzer and the second spectrum analyzer.

4. The system of claim 1 wherein the first spectrum analyzer and the second spectrum analyzer are frequency-aligned via an internal reference signal of one of the first spectrum analyzer and the second spectrum analyzer that is provided to the other of the first spectrum analyzer and the second spectrum analyzer.

5. The system of claim 1 wherein the first measured signal and the second measured signal are time-aligned via a trigger signal applied to the first spectrum analyzer and the second spectrum analyzer.

6. The system of claim 1 wherein the controller subtracts the approximated mean power of the input signal from an average of the multiple acquisitions of the first measured signal to approximate the mean power of the noise of the first spectrum analyzer.

7. A system, comprising:
measuring an input signal with a first spectrum analyzer to provide a first measured signal, and measuring the input signal with a second spectrum analyzer to provide a second measured signal, wherein the first spectrum analyzer and the second spectrum analyzer are time-aligned and frequency-aligned; and
averaging a cross-correlation of multiple acquisitions of the first measured signal and the second measured signal to approximate the mean power of the input signal.

8. The system of claim 7 wherein the number of multiple acquisitions of the first measured signal and the second measured signal is sufficiently high to approximate the mean power of the input signal to within a designated error.

9. The system of claim 7 wherein the first spectrum analyzer and the second spectrum analyzer are frequency-aligned via an external reference signal that is provided to the first spectrum analyzer and the second spectrum analyzer.

10. The system of claim 7 wherein the first spectrum analyzer and the second spectrum analyzer are frequency-aligned via an internal reference signal of one of the first spectrum analyzer and the second spectrum analyzer that is provided to the other of the first spectrum analyzer and the second spectrum analyzer.

11. The system of claim 7 wherein the first measured signal and the second measured signal are time-aligned via a trigger signal applied to the first spectrum analyzer and the second spectrum analyzer.

12. The system of claim 7 further comprising subtracting the approximated mean power of the input signal from an average of the multiple acquisitions of first measured signal to approximate the mean power of the noise of the first spectrum analyzer.

13. A system, comprising:
measuring a first signal with two spectrum analyzers that are time-aligned and frequency-aligned, a first spectrum analyzer of the two spectrum analyzers providing a first measured signal and a second spectrum analyzer of the two spectrum analyzers providing a second measured signal;
averaging a cross-correlation of the first measured signal and the second measured signal over multiple acquisitions of the first measured signal and the second measured signal to approximate the mean power of the first signal; and
subtracting the approximated mean power of the first signal from an average of the multiple acquisitions of the first measured signal to approximate the mean power of the noise of the first spectrum analyzer.

14. The system of claim 13 further comprising acquiring multiple acquisitions of a measured signal with the first spectrum analyzer in response to a second signal applied to the first spectrum analyzer, and subtracting the approximated power of the noise of the first spectrum analyzer from an average of the multiple acquisitions of the measured signal to approximate the mean power of the second signal.

15. The system of claim 13 wherein the number of the multiple acquisitions of the first measured signal and the second measured signal is sufficiently high to approximate the mean power of the first signal to within a designated error.

16. The system of claim 14 wherein the number of multiple acquisitions of the measured signal is sufficiently high to approximate the mean power of the second signal to within a designated error.

17. The system of claim 13 wherein the two spectrum analyzers are frequency-aligned via an external reference signal that is provided to the first spectrum analyzer and the second spectrum analyzer.

18. The system of claim 14 wherein the two spectrum analyzers are frequency-aligned via an external reference signal that is provided to the first spectrum analyzer and the second spectrum analyzer.

19. The system of claim 13 wherein the two spectrum analyzers are frequency-aligned via an internal reference signal of one of the first spectrum analyzer and the second spectrum analyzer that is provided to the other of the first spectrum analyzer and the second spectrum analyzer.

20. The system of claim 13 wherein the first measured signal and the second measured signal are time-aligned via a trigger signal applied to the first spectrum analyzer and the second spectrum analyzer.
